(19) United States
(12) Patent Application Publication
(10) Pub. No.: US 2021/0171189 A1
(43) Pub. Date: Jun. 10, 2021

(54) HIGH-SPEED TAKE-OFF AND LANDING ANTI-FALLING AIRPLANE

(71) Applicant: Zhichang Mu, Lhasa (CN)

(72) Inventor: Zhichang Mu, Lhasa (CN)

(21) Appl. No.: 16/995,989

(22) Filed: Aug. 18, 2020

(30) Foreign Application Priority Data
Dec. 10, 2019 (CN) 201911260448.6

(51) Int. Cl. B64C 19/02; B64C 39/08; B64C 3/32; B64C 3/38; B64C 3/54; B64D 25/00; B64D 17/78; B64F 1/06; B64C 25/34

(52) U.S. Cl. CPC B64C 19/02; B64C 39/08; B64C 3/32; B64C 3/38; B64C 25/34; B64D 25/00; B64D 17/78; B64F 1/06; B64C 3/54

(57) ABSTRACT

The present invention discloses a high-speed take-off and landing anti-falling airplane. The airplane includes an fuselage, wing mechanisms are provided on the fuselage, each wing mechanism includes a main wing, an invisible wing, a slow descent wing, a layer wing, an empennage, a slow descent wing adjusting mechanism, an invisible wing adjusting mechanism and a layer wing adjusting mechanism, the layer wings are provided on the upper side and the lower side of each main wing respectively, and the layer wing adjusting mechanisms are provided on the inner sides of the layer wings; the front end of the layer wing adjusting mechanism is fixedly connected with the inner side of the layer wing; according to the high-speed take-off and landing anti-falling airplane, the take-off speed and safety are improved, and fuel consumption is reduced.

### TECHNICAL FIELD

The present invention relates to the field of a high-speed take-off and landing anti-falling airplane, in particular to a high-speed take-off and landing anti-falling airplane.

### BACKGROUND

Transport airplanes are divided into ordinary transport airplanes and strategic transport airplanes in size, divided into military, civil (cargo airplane), and general-purpose airplanes in use, divided into subsonic transport airplanes, supersonic transport airplanes, and hypersonic transport airplanes in speed, divided into middle-range airplanes and large-range airplanes in flying range, and divided into middle-sized airplanes and large-sized airplanes in load. Military transport airplanes are used to transport military personnel, weapons and other military supplies, which has a large load capacity and endurance, is capable of carrying out air transportation, airborne landing and airdrop, and ensures that the ground forces implement rapid maneuver from the air. There are complete communication and pilot devices on board, which can fly in day and night at various complicated meteorological conditions.

The military transport airplanes consist of a fuselage, a power device, a landing gear, an operating system, a communication device and a pilot device. The fuselage door is wide, and is opened from the front, the rear or the side, which is convenient for quickly loading and unloading large devices and materials. Most of the power devices are 2 to 4 turbofans or turboprop high-power engines. Most of the landing gears are multi-wheeled and equipped with a lifting mechanism to adjust the height of the engine room floor from the ground, which is convenient for loading and unloading operations under night combat conditions. Military transport airplanes are divided into strategic transport airplanes, tactical transport airplanes, and full-range transport airplanes. Civil transport airplanes are commonly referred to as civil aviation passenger airplanes. Unlike military transport airplanes, civil transport airplanes mainly pursue comfort and economic benefits. The familiar Boeing 747 and Airbus A380 are typical civil transport airplanes.

The take-off and landing process of the existing transport airplanes and the safety protection performance of the airplanes have great defects. By analyzing the long-distance take-off process of the existing transport airplanes, it not only requires a longer time and a longer runway and consumes more fuel, but also needs to set a landing gear to increase the weight of the airplane; these problems are very restrictive to the high-speed take-off of the transport airplanes.

At the same time, the existing transport airplane does not have a good safety anti-falling device. Since the airplane serves human beings, safety must be the first, but the designers of the existing transport airplane seem to be insufficiently sensitive to absolute safety. The vast majority of the existing transport airplanes only use simple parachutes for escape and rescue, without considering the anti-falling protection of the airplane itself; at the same time, the wing structure of the existing transport airplane is not reasonable enough, occupying large space and having heavy weight;

In addition, the landing process of the existing airplane also needs to slide for a long distance and a long time, so as to be low in landing speed, low in efficiency, energy-consuming, and low in safety. Such a landing method cannot meet the needs of high speed and safety.

### SUMMARY

An object of the present invention is to provide a high-speed take-off and landing anti-falling airplane to solve the above problems in the background.

To achieve the above object, the present invention provides the following technical solutions:

A high-speed take-off and landing anti-falling airplane, comprising an fuselage, wherein a wing mechanism is provided on the fuselage, the wing mechanism comprises a main wing, an invisible wing, a slow descent wing, a layer wing, an empennage, a slow descent wing adjusting mechanism, an invisible wing adjusting mechanism and a layer wing adjusting mechanism, the layer wings are provided on the upper side and the lower side of the main wing, respectively, and the layer wing adjusting mechanisms are provided on the inner sides of the layer wings; the front end of the layer wing adjusting mechanism is fixedly connected with the inner side of the layer wing; the front side and the rear side of the main wing are provided with a slow descent wing, respectively; the front side and the rear side of the main wing are provided with an installing groove, respectively, the slow descent wing is installed in the installing groove, the root of the slow descent wing is hinged to the main wing through bolts and nuts, a slow descent wing adjusting mechanism is provided in the installing groove, the front end is fixedly connected to the rear part of the slow descent wing through bolts and nuts; both sides of the fuselage are provided with a plurality of sets of invisible wings, the invisible wings are divided into two sections, the front part of the root section is provided with an extension section, an installing groove is provided in the root section, an invisible wing adjusting mechanism is provided in the installing groove, the rear part of the extension section is hinged to the root section through bolts and nuts, the front end of the invisible wing adjusting mechanism is connected to the rear part of the extension section through bolts and nuts; the rear part of the fuselage is provided with an empennage; the bottom of the main wing is provided with an engine; the bottom of the fuselage is provided with a buffer wheel; a protective device is provided on the fuselage, the protective device comprises an airbag and a parachute, two parachutes are provided above the fuselage; four airbags are provided at the bottom, front, left, and right positions of the bottom of the fuselage; a take-off platform is provided on the airport; a slideway is provided at the rear part of the take-off platform; a catapult chamber is provided below the take-off platform, a catapult mechanism is provided in the catapult chamber, the catapult mechanism comprises a steam catapult machine, a catapult trailer and a catapult tractor; the upper part of the steam catapult machine is provided with a catapult trailer, the bottom of the fuselage is provided with a catapult tractor matched with the catapult trailer; the rear side of the take-off platform is provided with a vehicle platform, the vehicle platform is provided with a landing vehicle, the landing vehicle is provided with a landing groove; the front and back sides of the landing groove are provided with locking devices, the locking device comprises a locking plate and a hydraulic device; and the bottom of the landing vehicle is provided with a driving device.

As a further solution of the present invention: the fuselage has a shuttle shape, the structure of the layer wing is the same as that of the main wing; the layer wing adjusting mechanism is a hydraulic device; the layer wing adjusting mechanism is fixed in the installing groove through bolts and nuts; an installing groove is provided in the main wing, the installing groove is provided with a chute, the layer wing is provided with a slide rail matched with the chute, and the layer wing is installed in the installing groove through the cooperation of the slide rail and the chute.

As a further solution of the present invention: the structure of the slow descent wing is the same as that of the main wing; the slow descent wing is arc-shaped; the slow descent wing adjusting mechanism is a hydraulic device; the slow descent wing adjusting mechanism is fixed laterally in the installing groove through bolts and nuts; the structure of the invisible wing is the same as that of the main wing, the invisible wing adjusting mechanism is a hydraulic device; the root section of the invisible wing and the fuselage form an integrated structure; the nozzle of the engine is an adjustable nozzle; and the buffer wheel is a rubber tire.

As a further solution of the present invention: the take-off platform is in a circular arc shape, the take-off platform has a concrete structure, the slideway is provided with a chute; and the steam catapult machine is fixed in the catapult chamber.

As a further solution of the present invention: the landing vehicle is a flatbed vehicle; the landing vehicle is provided with a hydraulic device, the hydraulic device is vertically fixed on the landing vehicle through bolts and nuts, and the bottom of the locking plate is fixedly connected with the front end of the hydraulic device.

As a further solution of the present invention: slide rails are provided on both sides of the locking plate, the landing vehicle is provided with a chute matched with the slide rail, the locking plate is matched with the chute through the slide rail and is connected to the landing vehicle; and the minimum height of the locking plate is equal to the height of the landing groove.

As a further solution of the present invention: a buffer device and a balancing device are provided at the bottom of the landing groove; the driving device is electrically driven, and the driving device is controlled by remote control or automatically.

Compared with the prior art, the beneficial effect of the present invention is that the high-speed take-off and landing anti-drop airplane changes the original sliding take-off method into a catapult-type take-off, and removes the original landing gear, which not only reduces the weight of the airplane, but also greatly improves the take-off speed and safety, and reduces fuel consumption.

By redesigning the original wings, the length of the original main wing is shortened, the weight of the main wing is reduced, an invisible wing, a slow descent wing and a layer wing are added, and the resistance adjusting function in the flying and taking-off and landing processes of the airplane is improved, and therefore the safety of the airplane is greatly improved; the structure is simple, and control is convenient; by providing a parachute on the upper part of the fuselage and an airbag on the lower part of the fuselage, the safety protection measures of the airplane are increased, and the safety of the airplane is greatly improved; an adjustable nozzle is used for the engine, enhancing the thrust adjusting function of the engine, and enhancing the control performance of the airplane, thereby improving safety.

By changing the original sliding landing method into the method of directly landing on the landing vehicle, the landing speed is increased, the landing time is saved, the power consumption is reduced, and the landing safety and convenience are improved; at the same time, the landing vehicle carries the airplane so that it is easier and more convenient to carry the airplane.

### BRIEF DESCRIPTION OF THE DRAWINGS

FIG. 1 is a top schematic diagram of a high-speed take-off and landing anti-falling airplane.

FIG. 2 is a top schematic diagram of a slow descent wing of a high-speed take-off and landing anti-falling airplane.

FIG. 3 is a schematic structural diagram of a slow-falling wing adjusting mechanism of a high-speed take-off and landing anti-falling airplane.

FIG. 4 is a bottom schematic diagram of a high-speed take-off and landing anti-falling airplane.

FIG. 5 is a front schematic diagram of a high-speed take-off and landing anti-falling airplane.

FIG. 6 is a schematic structural diagram of an invisible wing adjusting mechanism of a high-speed take-off and landing anti-drop airplane.

FIG. 7 is a top schematic diagram of an airport in a high-speed take-off and landing anti-falling airplane.

FIG. 8 is a front schematic view of an airport in a high-speed take-off and landing anti-falling airplane.

FIG. 9 is a schematic structural diagram of a landing vehicle of a high-speed take-off and landing anti-falling airplane.

In the figures: a fuselage 1, a wing mechanism 2, a main wing 3, an invisible wing 4, a slow descent wing 5, a slow descent wing adjusting mechanism 6, an invisible wing adjusting mechanism 7, a layer wing 8, a layer wing adjusting mechanism 9, an empennage 10, a buffer wheel 11, a protective device 12, an airbag 13, an engine 14, a landing vehicle 15, a parachute 16, an airport 17, a catapult chamber 18, a catapult mechanism 19, a steam catapult machine 20, a catapult trailer 21, a catapult tractor 22, a slideway 23, a take-off platform 24, a vehicle platform 25, a landing groove 26, a driving device 27, a locking device 28, a locking plate 29.

### DESCRIPTION OF THE EMBODIMENTS

The technical solutions in the embodiments of the present invention will be described clearly and completely in conjunction with the drawings in the embodiments of the present invention. Obviously, the described embodiments are only a part of the embodiments of the present invention, rather than all the embodiments. Based on the embodiments of the present invention, all other embodiments obtained by those skilled in the art without paying creative labor fall within the protection scope of the present invention.

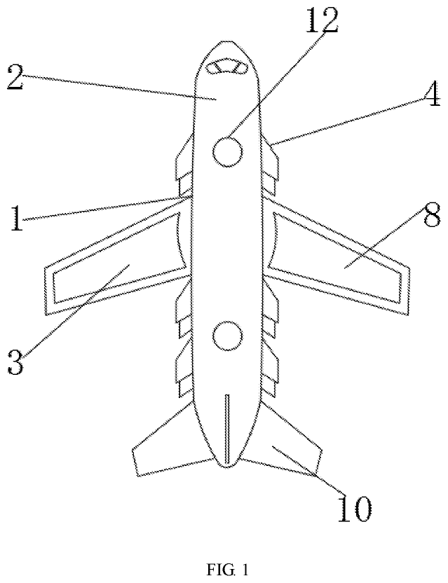

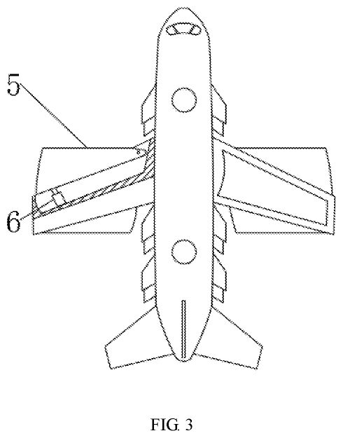

Referring to FIGS. 1 to 3, in an embodiment of the present invention, a high-speed take-off and landing anti-falling airplane comprises an fuselage 1, wherein a wing mechanism 2 is provided on the fuselage 1, the wing mechanism 2 comprises a main wing 3, an invisible wing 4, a slow descent wing 5, a layer wing 8, an empennage 10, a slow descent wing adjusting mechanism 6, an invisible wing adjusting mechanism 7 and a layer wing adjusting mechanism 9, the layer wings 8 are provided on the upper side and the lower side of the main wing 3, respectively, the structure of the slow descent wing 5 is the same as that of the main wing 3; the layer wing adjusting mechanisms 9 are provided on the inner sides of the layer wings 8; the layer wing adjusting mechanism 9 is a hydraulic device; an installing groove is provided in the main wing 3, the installing groove is provided with a chute, the layer wing 8 is provided with a slide rail matched with the chute, the layer wing 8 is installed in the installing groove through the cooperation of the slide rail and the chute; the layer wing adjusting mechanism 9 is fixed in the installing groove through bolts and nuts, the front end of the layer wing adjusting mechanism 9 is fixedly connected with the inner side of the layer wing 8; the layer wing adjusting mechanism 9 is used to adjust the expansion and contraction of the layer wing 8; the layer wing 8 is used to conveniently adjust the landing resistance, thereby improving the landing and flying efficiency and safety; the front side and the rear side of the main wing 3 are provided with a slow descent wing 5, respectively; the structure of the slow descent wing 5 is the same as that of the main wing 3, the slow descent wing 5 is arc-shaped; the front side and the rear side of the main wing 3 are provided with an installing groove, respectively, the slow descent wing 5 is installed in the installing groove, the root of the slow descent wing 5 is hinged to the main wing 3 through bolts and nuts, a slow descent wing 5 adjusting mechanism 6 is provided in the installing groove, the slow descent wing 5 adjusting mechanism 6 is a hydraulic device, the slow descent wing 5 adjusting mechanism 6 is fixed laterally in the installing groove through bolts and nuts, the front end of the slow descent wing 5 adjusting mechanism 6 is fixedly connected to the rear part of the slow descent wing 5 through bolts and nuts; the slow descent wing 5 adjusting mechanism 6 is used to adjust the expansion and contraction of the slow descent wing 5; and the slow descent wing 5 is used to adjust the area of the main wing 3, so that the main wing 3 expands into a rectangle, which improves the stability and safety of landing while adjusting the landing resistance.

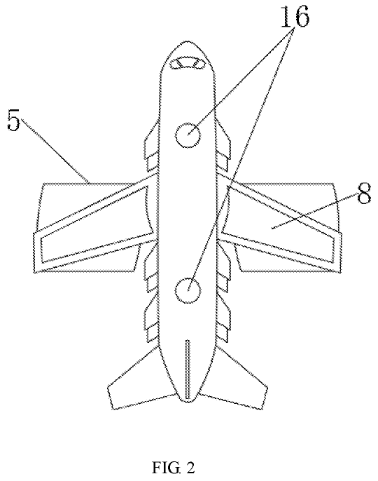

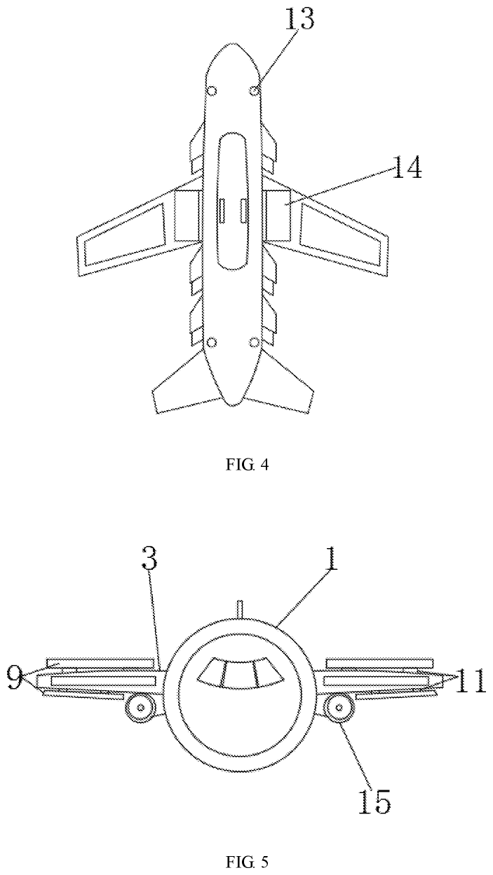

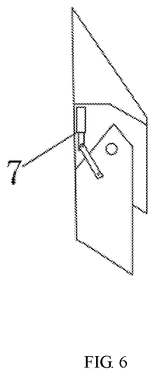

Referring to FIG. 1, FIG. 2, FIG. 4, FIG. 5 and FIG. 6, in the embodiment of the present invention, both sides of the fuselage 1 are provided with a plurality of sets of invisible wings 4, the structure of the invisible wing 4 is the same as that of the main wing 3, the invisible wings 4 are divided into two sections, the root section of the invisible wing 4 and the fuselage 1 form an integrated structure, the front part of the root section is provided with an extension section, an installing groove is provided in the root section, an invisible wing adjusting mechanism 7 is provided in the installing groove, the invisible wing adjusting mechanism 7 is a hydraulic device, the rear part of the extension section is hinged to the root section through bolts and nuts, the front end of the invisible wing adjusting mechanism 7 is connected to the rear part of the extension section through bolts and nuts; the extension mechanism of the invisible wing 4 is used to adjust the expansion and contraction of the invisible wing 4, the invisible wing 4 is used to adjust the flight and landing resistance; the rear part of the fuselage 1 is provided with an empennage 10; the bottom of the main wing 3 is provided with an engine 14, the nozzle of the engine 14 is an adjustable nozzle, the adjustable nozzle is provided in order to conveniently adjust the thrust direction of the engine 14 so as to realize the propulsion and lifting functions of the engine 14; the bottom of the fuselage 1 is provided with a buffer wheel 11, the buffer wheel 11 is a rubber tire, the buffer wheel 11 is used to reduce the sliding resistance when catapulting the airplane and is used to buffer and dampen the airplane when the airplane is landing; a protective device 12 is provided on the fuselage 1, the protective device 12 comprises an airbag 13 and a parachute 16, two parachutes 16 are provided above the fuselage 1, the parachute 16 is used to increase the landing resistance and enhance the safety of the airplane; four airbags 13 are provided at the bottom, front, left, and right positions of the bottom of the fuselage 1; the airbags 13 are used to increase the resistance of the airplane during an emergency landing, and are also used to buffer the airplane during emergency landing so as to improve the safety of the airplane.

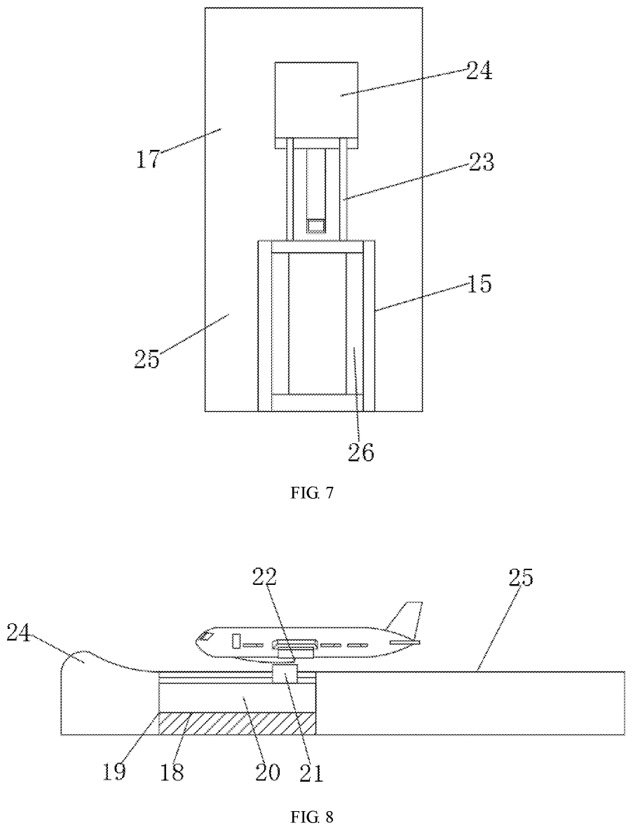

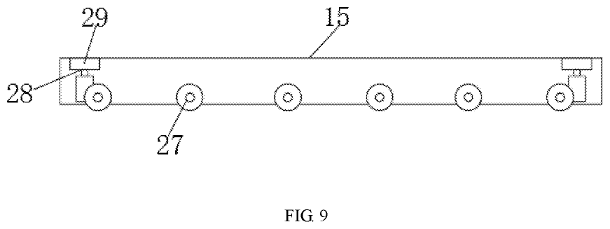

Referring to FIGS. 7-9, in the embodiment of the present invention, a take-off platform 24 is provided on the airport 17, the take-off platform 24 is in a circular arc shape, the take-off platform 24 has a concrete structure; a slideway 23 is provided at the rear part of the take-off platform 24, the slideway 23 is provided with a chute, the chute is used to cooperate with the buffer wheel 11 provided at the bottom of the fuselage 1 to achieve the limit of the sliding of the airplane; a catapult chamber 18 is provided below the take-off platform 24, a catapult mechanism 19 is provided in the catapult chamber 18, the catapult mechanism 19 comprises a steam catapult machine 20, a catapult trailer 21 and a catapult tractor 22, the steam catapult machine 20 is fixed in the catapult chamber 18; the upper part of the steam catapult machine 20 is provided with a catapult trailer 21, the bottom of the fuselage 1 is provided with a catapult tractor 22 matched with the catapult trailer 21, the steam catapult machine 20, the catapult trailer 21 and the catapult tractor 22 are used to catapult and drag the airplane so that the airplane rapidly catapults and takes off; the rear side of the take-off platform 24 is provided with a vehicle platform 25, the vehicle platform 25 is provided with a landing vehicle 15, the landing vehicle 15 is a flatbed vehicle, the landing vehicle 15 is provided with a landing groove 26, the landing groove 26 is used to limit the airplane so that the airplane is fixed in the landing groove 26 after landing, so as to prevent sliding during transportation; the front and back sides of the landing groove 26 are provided with locking devices 28, the locking device 28 comprises a locking plate 29 and a hydraulic device, the landing vehicle 15 is provided with a hydraulic device, the hydraulic device is vertically fixed on the landing vehicle 15 through bolts and nuts, and the bottom of the locking plate 29 is fixedly connected with the front end of the hydraulic device; slide rails are provided on both sides of the locking plate 29, the landing vehicle 15 is provided with a chute matched with the slide rail, the locking plate 29 is matched with the chute through the slide rail and is connected to the landing vehicle 15; the minimum height of the locking plate 29 is equal to the height of the landing groove 26; the purpose of the configuration is to facilitate the airplane to slide in the landing groove 26; a buffer device and a balancing device are provided at the bottom of the landing groove 26, the buffer device and the balance device are used to buffer and balance the airplane; the bottom of the landing vehicle 15 is provided with a driving device 27, the driving device 27 is electrically driven, the driving device 27 is used to drive the landing vehicle 15 to travel; the driving device 27 is controlled by remote control or automatically; and the landing vehicle 15 is used to support the landing of the airplane, transport the airplane, and carry the airplane to the getting-off station.

In use, when taking off, the airplane is carried to the vehicle platform 25 by the landing vehicle 15, and then the airplane moves forward to the take-off platform 24, so that the catapult trailer 21 drags the catapult tractor 22, the steam catapult machine 20 then drags and catapults the airplane, and then the airplane catapults to the take-off platform 24 and takes off;

when the airplane is landing or in an emergency, the slow descent wing 5, the invisible wing 4 and the layer wing 8 are controlled to adjust the extension or contraction by the slow descent wing adjusting mechanism 6, the invisible wing adjusting mechanism 7, and the layer wing adjusting mechanism 9, respectively, so as to control the descent and flight resistance of the airplane; alternatively, the thrust direction is adjusted by the adjustable nozzle of the engine 14 to adjust the descent or flight resistance;

when the airplane is landing, the airplane lands into the landing groove 26 of the landing vehicle 15 first, and then is locked by the locking device 28, when the locking device 28 is operating, the hydraulic device drags the locking plate 29 to rise, so as to achieve limiting and fixing the airplane; and then the landing vehicle 15 carries the airplane to the getting-off station.

Although the present invention has been described in detail with reference to the foregoing embodiments, those skilled in the art can still modify the technical solutions described in the foregoing embodiments, or equivalently replace some of the technical features therein. Any modifications, equivalent replacements, improvements, etc., which are made within the spirit and principle of the present invention, shall be included in the protection scope of the present invention.

1. A high-speed take-off and landing anti-falling airplane, comprising an fuselage, wherein a wing mechanism provided on the fuselage, the wing mechanism comprises a main wing, an invisible wing, a slow descent wing, a layer wing, an empennage, a slow descent wing adjusting mechanism, an invisible wing adjusting mechanism and a layer wing adjusting mechanism, the layer wings are provided on the upper side and the lower side of the main wing, respectively, and the layer wing adjusting mechanisms are provided on the inner sides of the layer wings; the front end of the layer wing adjusting mechanism is fixedly connected with the inner side of the layer wing; the front side and the rear side of the main wing are provided with a slow descent wing, respectively; the front side and the rear side of the main wing are provided with an installing groove, respectively, the slow descent wing is installed in the installing groove, the root of the slow descent wing is hinged to the main wing through bolts and nuts, a slow descent wing adjusting mechanism is provided in the installing groove, the front end is fixedly connected to the rear part of the slow descent wing through bolts and nuts; both sides of the fuselage are provided with a plurality of sets of invisible wings, the invisible wings are divided into two sections, the front part of the root section is provided with an extension section, an installing groove is provided in the root section, an invisible wing adjusting mechanism is provided in the installing groove, the rear part of the extension section is hinged to the root section through bolts and nuts, the front end of the invisible wing adjusting mechanism is connected to the rear part of the extension section through bolts and nuts; the rear part of the fuselage is provided with an empennage; the bottom of the main wing is provided with an engine; the bottom of the fuselage is provided with a buffer wheel; a protective device is provided on the fuselage, the protective device comprises an airbag and a parachute, two parachutes are provided above the fuselage; four airbags are provided at the bottom, front, left, and right positions of the bottom of the fuselage (1); a take-off platform is provided on the airport; a slideway is provided at the rear part of the take-off platform; a catapult chamber is provided below the take-off platform, a catapult mechanism is provided in the catapult chamber, the catapult mechanism comprises a steam catapult machined, a catapult trailer and a catapult tractor; the upper part of the steam catapult machine is provided with a catapult trailer, the bottom of the fuselage is provided with a catapult tractor matched with the catapult trailer; the rear side of the take-off platform is provided with a vehicle platform, the vehicle platform is provided with a landing vehicle, the landing vehicle is provided with a landing groove; the front and back sides of the landing groove are provided with locking devices, the locking device comprises a locking plate and a hydraulic device; and the bottom of the landing vehicle is provided with a driving device.

2. The high-speed take-off and landing anti-falling airplane according to claim 1, wherein the fuselage has a shuttle shape, the structure of the layer wing is the same as that of the main wing; the layer wing adjusting mechanism is a hydraulic device; the layer wing adjusting mechanism is fixed in the installing groove through bolts and nuts; an installing groove is provided in the main wing, the installing groove is provided with a chute, the layer wing is provided with a slide rail matched with the chute, and the layer wing is installed in the installing groove through the cooperation of the slide rail and the chute.

3. The high-speed take-off and landing anti-falling airplane according to claim 1, wherein the structure of the slow descent wing is the same as that of the main wing; the slow descent wing is arc-shaped; the slow descent wing adjusting mechanism is a hydraulic device; the slow descent wing adjusting mechanism is fixed laterally in the installing groove through bolts and nuts; the structure of the invisible wing is the same as that of the main wing, the invisible wing adjusting mechanism is a hydraulic device; the root section of the invisible wing and the fuselage form an integrated structure; the nozzle of the engine is an adjustable nozzle; and the buffer wheel is a rubber tire.

4. The high-speed take-off and landing anti-falling airplane according to claim 1, wherein the take-off platform is in a circular arc shape, the take-off platform has a concrete structure, the slideway is provided with a chute; and the steam catapult machine is fixed in the catapult chamber.

5. The high-speed take-off and landing anti-falling airplane according to claim 1, wherein the landing vehicle is a flatbed vehicle; the landing vehicle is provided with a hydraulic device, the hydraulic device is vertically fixed on the landing vehicle through bolts and nuts, and the bottom of the locking plate is fixedly connected with the front end of the hydraulic device.

6. The high-speed take-off and landing anti-falling airplane according to claim 1, wherein slide rails are provided on both sides of the locking plate, the landing vehicle is provided with a chute matched with the slide rail, the locking plate is matched with the chute through the slide rail and is connected to the landing vehicle; and the minimum height of the locking plate is equal to the height of the landing groove.

7. The high-speed take-off and landing anti-falling airplane according to claim 1, wherein a buffer device and a balancing device are provided at the bottom of the landing groove; the driving device is electrically driven, and the driving device is controlled by remote control or automatically.

8. The high-speed take-off and landing anti-falling airplane according to claim 1, wherein when taking off, the airplane is carried to the vehicle platform by the landing vehicle, and then the airplane moves forward to the take-off platform, so that the catapult trailer drags the catapult tractor, the steam catapult machine then drags and catapults the airplane, and then the airplane catapults to the take-off platform and takes off; when the airplane is landing or in an emergency, the slow descent wing, the invisible wing and the layer wing are controlled to adjust the extension or contraction by the slow descent wing adjusting mechanism, the invisible wing adjusting mechanism, and the layer wing adjusting mechanism, respectively, so as to control the descent and flight resistance of the airplane; alternatively, the thrust direction is adjusted by the adjustable nozzle of the engine to adjust the descent or flight resistance; when the airplane is landing, the airplane lands into the landing groove of the landing vehicle first, and then is locked by the locking device, when the locking device is operating, the hydraulic device drags the locking plate to rise, so as to achieve limiting and fixing the airplane; and then the landing vehicle carries the airplane to the getting-off station.

9. The high-speed take-off and landing anti-falling airplane according to claim 2, wherein when taking off, the airplane is carried to the vehicle platform by the landing vehicle, and then the airplane moves forward to the take-off platform, so that the catapult trailer drags the catapult tractor, the steam catapult machine then drags and catapults the airplane, and then the airplane catapults to the take-off platform and takes off; when the airplane is landing or in an emergency, the slow descent wing, the invisible wing and the layer wing are controlled to adjust the extension or contraction by the slow descent wing adjusting mechanism, the invisible wing adjusting mechanism, and the layer wing adjusting mechanism, respectively, so as to control the descent and flight resistance of the airplane; alternatively, the thrust direction is adjusted by the adjustable nozzle of the engine to adjust the descent or flight resistance; when the airplane is landing, the airplane lands into the landing groove of the landing vehicle first, and then is locked by the locking device, when the locking device is operating, the hydraulic device drags the locking plate to rise, so as to achieve limiting and fixing the airplane; and then the landing vehicle carries the airplane to the getting-off station.

10. The high-speed take-off and landing anti-falling airplane according to claim 3, wherein when taking off, the airplane is carried to the vehicle platform by the landing vehicle, and then the airplane moves forward to the take-off platform, so that the catapult trailer drags the catapult tractor, the steam catapult machine then drags and catapults the airplane, and then the airplane catapults to the take-off platform and takes off; when the airplane is landing or in an emergency, the slow descent wing, the invisible wing and the layer wing are controlled to adjust the extension or contraction by the slow descent wing adjusting mechanism, the invisible wing adjusting mechanism, and the layer wing adjusting mechanism, respectively, so as to control the descent and flight resistance of the airplane; alternatively, the thrust direction is adjusted by the adjustable nozzle of the engine to adjust the descent or flight resistance; when the airplane is landing, the airplane lands into the landing groove of the landing vehicle first, and then is locked by the locking device, when the locking device is operating, the hydraulic device drags the locking plate to rise, so as to achieve limiting and fixing the airplane; and then the landing vehicle carries the airplane to the getting-off station.

11. The high-speed take-off and landing anti-falling airplane according to claim 4, wherein when taking off, the airplane is carried to the vehicle platform by the landing vehicle, and then the airplane moves forward to the take-off platform, so that the catapult trailer drags the catapult tractor, the steam catapult machine then drags and catapults the airplane, and then the airplane catapults to the take-off platform and takes off; when the airplane is landing or in an emergency, the slow descent wing, the invisible wing and the layer wing are controlled to adjust the extension or contraction by the slow descent wing adjusting mechanism, the invisible wing adjusting mechanism, and the layer wing adjusting mechanism, respectively, so as to control the descent and flight resistance of the airplane; alternatively, the thrust direction is adjusted by the adjustable nozzle of the engine to adjust the descent or flight resistance; when the airplane is landing, the airplane lands into the landing groove of the landing vehicle first, and then is locked by the locking device, when the locking device is operating, the hydraulic device drags the locking plate to rise, so as to achieve limiting and fixing the airplane; and then the landing vehicle carries the airplane to the getting-off station.

12. The high-speed take-off and landing anti-falling airplane according to claim 5, wherein when taking off, the airplane is carried to the vehicle platform by the landing vehicle, and then the airplane moves forward to the take-off platform, so that the catapult trailer drags the catapult tractor, the steam catapult machine then drags and catapults the airplane, and then the airplane catapults to the take-off platform and takes off; when the airplane is landing or in an emergency, the slow descent wing, the invisible wing and the layer wing are controlled to adjust the extension or contraction by the slow descent wing adjusting mechanism, the invisible wing adjusting mechanism, and the layer wing adjusting mechanism, respectively, so as to control the descent and flight resistance of the airplane; alternatively, the thrust direction is adjusted by the adjustable nozzle of the engine to adjust the descent or flight resistance; when the airplane is landing, the airplane lands into the landing groove of the landing vehicle first, and then is locked by the locking device, when the locking device is operating, the hydraulic device drags the locking plate to rise, so as to achieve limiting and fixing the airplane; and then the landing vehicle carries the airplane to the getting-off station.

13. The high-speed take-off and landing anti-falling airplane according to claim 6, wherein when taking off, the airplane is carried to the vehicle platform by the landing vehicle, and then the airplane moves forward to the take-off platform, so that the catapult trailer drags the catapult tractor, the steam catapult machine then drags and catapults the airplane, and then the airplane catapults to the take-off platform and takes off; when the airplane is landing or in an emergency, the slow descent wing, the invisible wing and the layer wing are controlled to adjust the extension or contraction by the slow descent wing adjusting mechanism, the invisible wing adjusting mechanism, and the layer wing adjusting mechanism, respectively, so as to control the descent and flight resistance of the airplane; alternatively, the thrust direction is adjusted by the adjustable nozzle of the engine to adjust the descent or flight resistance; when the airplane is landing, the airplane lands into the landing groove of the landing vehicle first, and then is locked by the locking device, when the locking device is operating, the hydraulic device drags the locking plate to rise, so as to achieve limiting and fixing the airplane; and then the landing vehicle carries the airplane to the getting-off station.

14. The high-speed take-off and landing anti-falling airplane according to claim 7, wherein when taking off, the airplane is carried to the vehicle platform by the landing vehicle, and then the airplane moves forward to the take-off platform, so that the catapult trailer drags the catapult tractor, the steam catapult machine then drags and catapults the airplane, and then the airplane catapults to the take-off platform and takes off; when the airplane is landing or in an emergency, the slow descent wing, the invisible wing and the layer wing are controlled to adjust the extension or contraction by the slow descent wing adjusting mechanism, the invisible wing adjusting mechanism, and the layer wing adjusting mechanism, respectively, so as to control the descent and flight resistance of the airplane; alternatively, the thrust direction is adjusted by the adjustable nozzle of the engine to adjust the descent or flight resistance; when the airplane is landing, the airplane lands into the landing groove of the landing vehicle first, and then is locked by the locking device, when the locking device is operating, the hydraulic device drags the locking plate to rise, so as to achieve limiting and fixing the airplane; and then the landing vehicle carries the airplane to the getting-off station.
